(19) United States
(12) Patent Application Publication
(10) Pub. No.: US 2011/0300850 A1
(43) Pub. Date: Dec. 8, 2011

(54) TWO-WAY WIRELESS COMMUNICATION APPARATUS AND SYSTEM APPLYING THE SAME

(75) Inventors: WEN-YI KUO, TAIPEI CITY (TW); YUEH-FENG LEE, TAIPEI COUNTY (TW)

(73) Assignee: BANDRICH, INC., TAIPEI COUNTY (TW)

(21) Appl. No.: 12/795,794

(22) Filed: Jun. 8, 2010

(51) Int. Cl. H04W 40/00

(52) U.S. Cl. 455/422.1

(57) ABSTRACT

Disclosed is a two-way wireless communication apparatus. According to one embodiment of the present invention, the two-way wireless communication apparatus mainly includes a mobile communication module and a femtocell module. The mobile communication module has a first antenna for extending wireless signals, especially for extending the outdoor mobile communication signals. The femtocell module has a second antenna for providing a mobile coverage, especially for the end devices that user uses indoor. More particularly, the claimed two-way wireless communication apparatus uses a signaling means to link the mobile communication module and the femtocell module, and to exchange the downlink and uplink signals there-between. The two-way wireless communication apparatus is preferably capable of bridging at least two mobile communication networks.

### BACKGROUND OF THE INVENTION

1. Field of the Invention

The present invention relates to a two-way wireless communication apparatus and a system applying the same, in particular, this invention relates to a femtocell device with two-way wireless communication scenario, and a communication system that incorporates the femtocell device.

2. Description of Related Art

In order to provide high-quality cellular phone reception within your home, the conventional technology develops a concept of femtocell station that allows a user unlimited voice and data usage with a very convenient way. This femtocell station improves local wireless coverage since it is usually placed in a home or office.

FIG. 1 illustrates a system architecture diagram of a conventional network layout using a femtocell concept. It shows a femtocell station 18 disposed between a wired DSL-based system and a wireless network environment. According to the conventional femtocell concept, the femtocell station provides a mobile network coverage for the end users to get on the Internet as its WAN port is connected with the DSL network. For example, one connection port of the shown femtocell station 18 is connected with an IP network 14 via a DSL modem 16, which is the device usually placed at home or office.

In another example, the DSL-based system can be replaced with the traditional cable modem and its extended network service. The femtocell station may also bridge the local mobile signals from the devices 101, 102 to the IP network 14 over the cable-based system.

Furthermore, through a kind of femtocell gateway 12, the network may extend to the other mobile-based network 10. The femtocell station 18 can supply a mobile coverage (3G/3.5G/HSDPA) to the end user devices, such as the shown wireless-capable cellular phone 101 and computer 102. In practice, at home or office, the femtocell station 18 routes the mobile traffic to Internet over the DSL-based system. The mobile traffic can be routed to the other end, probably the devices covered by the other mobile network 10, via the IP network 14.

The proximity of the femtocell station 18 enables a high quality link, while the femtocell concept overcomes the limitation of the traditional 3G/3.5G/HSDPA signals from the base station. The users may easily get the high-speed access to mobile data services such as browsing the Internet, downloading music, and streaming video.

### SUMMARY OF THE INVENTION

To improve and extend the conventional femtocell concept, one particular aspect of the present invention is to provide a two-way wireless communication apparatus and a system applying the same.

According to one embodiment of the present invention, the two-way wireless communication apparatus mainly includes a mobile communication module and a femtocell module. That femtocell module is the circuit module of a conventional femtocell station, which has a second antenna for providing one mobile coverage, especially for the end devices that user uses. The mobile communication module is coupled with the femtocell module. This mobile communication module has a first antenna for receiving and transmitting the wireless signals, especially for spanning the outdoor mobile communication signals.

More particularly, the claimed two-way wireless communication apparatus uses a signaling means to link the mobile communication module and the femtocell module, and to function as a connection for exchanging the downlink and uplink signals there-between.

In which, by the signaling means, the femtocell module has a femtocell baseband linking to a user-equipment baseband of the mobile communication module. Preferably, the signaling means is implemented by a USB connection, or an Ethernet connection.

Another particular aspect of the present invention is to provide a system applying the two-way wireless communication apparatus. The system mainly includes the claimed femtocell station and a remote computer system. The femtocell station has a mobile communication module having a first antenna for extending the wireless signals, and a femtocell module having a second antenna for providing one mobile coverage. Further, the remote computer system is preferably supplied for the operators to access the femtocell station using a very efficient way. Since the remote computer system links with the femtocell station via a wireless network, at least the terminal wireless connection, it's very convenient for the operators to remotely perform configuration to the femtocell station rather than the conventional manner by which it is necessary to penetrate the DSL-based network and the related devices.

For further understanding of this invention, reference is made to the following detailed description illustrating the embodiments and exemplifying of the invention. The description is, of course useful solely for illustrative purposes relating to the invention and is not intended to be considered limiting of the scope of the claims, in which the only complete description of the invention is found.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a system architecture diagram of a conventional femtocell station;

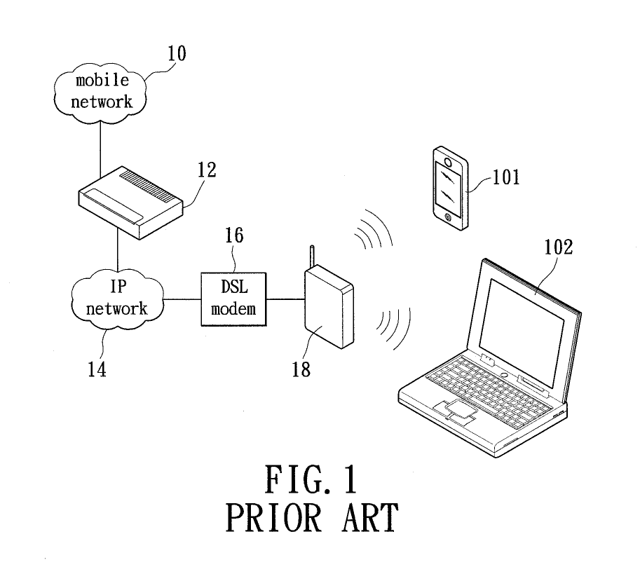

FIG. 2 schematically illustrates a design of the femtocell station in accordance with the present invention;

FIG. 3 shows a schematic diagram of a system using a two-way wireless communication apparatus in accordance with the present invention;

FIG. 4 describes a modular block diagram of the two-way wireless communication apparatus in accordance with the present invention;

FIG. 5 describes a circuit diagram of the two-way wireless communication apparatus in accordance with the present invention.

### DETAILED DESCRIPTION OF THE PREFERRED EMBODIMENTS

While the present invention will be described more fully hereinafter with reference to the accompanying drawings, in which at least a preferred embodiment of the present invention is shown, it is to be understood at the outset of the description which follows that persons of skill in the appropriate arts may modify the invention here described while still achieving the favorable results of the invention. Accordingly, with this recognition, the description which follows is to be understood as being a broad, teaching disclosure directed to persons of skill in the appropriate arts, and not as limiting limitation of upon the present invention.

The present invention generally relates to a two-way wireless communication apparatus. Further, a wireless network system included in this invention is also provided in light of it's introduction of apparatus other than or beyond, the conventional or less evolved or innovative DSL-based femtocell station.

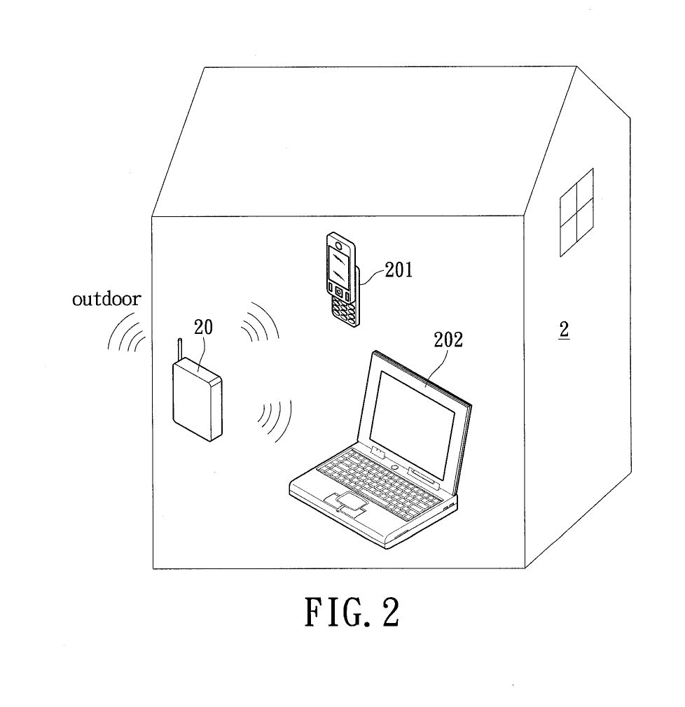

Reference is made to FIG. 2 which schematically illustrates a concept of the femtocell station in accordance with the present invention. The invention is generally implemented in an indoor space 2, such as at home, or in the office. A femtocell station 20 may be placed in that indoor space 2, and provided for the indoor electronic devices 201, 202 to optimize their communication signals. The femtocell station 20 may operate as a router which routes the signals generated by the electronic devices 201, 202 to other networks. The femtocell station 20 is capable of serving as a repeater to extend the wireless signals. More particularly, the provided femtocell station is a two-way wireless communication means useful in bridging indoor wireless communication signals and outdoor wireless networks.

In an embodiment, the femtocell station 20 has an indoor antenna which is handling transmission and reception of wireless signals of the indoor electronic devices 201, 202, and an outdoor antenna which is used to span the outside mobile signals. In a preferable embodiment, the claimed femtocell station 20 supports 3G, HSPA (High-Speed Packet Access), or/and LTE (Long Term Evolution). Therefore, both ways of antennas are capable of mastering those mobile communication systems. The femtocell station 20 is used to exchange and route the indoor and outdoor wireless signals.

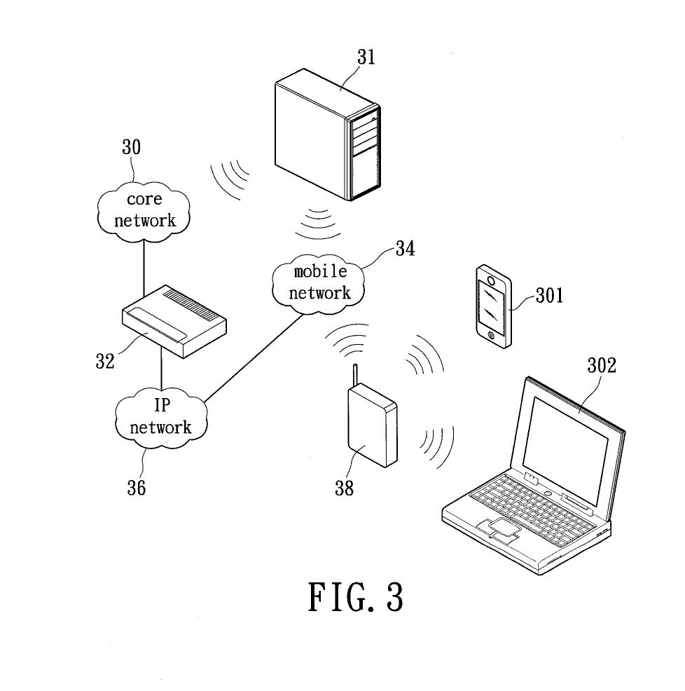

Moreover, reference is made to FIG. 3 showing a schematic diagram of a system using a two-way wireless communication apparatus in accordance with the present invention. Preferably, a femtocell station 38 is placed between two wireless network environments since it can be functioned to bridge two heterogeneous or homogeneous network systems. According to one of the embodiments of the present invention, the femtocell station 38 supplies a mobile network coverage for the user-end electronic devices, such as the shown mobile phone 301 or any terminal computer system 302. The mobile network, such as 3G, HSPA, LTE, or the like, is preferably provided.

For the WAN connection, rather than the conventional DSL or cable based network, the claimed femtocell station 38 is capable of wirelessly linking to a mobile network 34. Therefore, the user may abandon the facilities of the traditional DSL or cable based connection. The femtocell station 38 supplies the user-end devices 301, 302 to access any service such as voice and data or the digital content over the mobile network 34. Further, the mobile network 34 is an intermediary network to an IP network 36 to forward signals to and from a core network 30 using a gateway 32. The core network 30 is particularly indicative of the networking environment for the operator end or the networking service provider. More particularly, the gateway 32 may be implemented by a femtocell gateway.

It is worth noting that the abovementioned mobile network 34 can be a pure mobile network that needs not any traditional IP network to accomplish the remote access. A general mobile-networking service provider preferably constructs its own fundamental networking domain for supplying networking services to the end users. As shown in the diagram, network packets can be delivered from the femtocell station 38 wirelessly to a remote server over the mobile network 34. However, the mobile network 34 may be constructed over the traditional IP network 36 such as the optical-fiber network or wired backbone network. Thus, the mobile network 34 serves as a intermediary network for forwarding the network packets.

In an exemplary example, a remote computer system, such as an ISP-end workstation 31, may be placed within a network domain of a specific network environment that links with any existed network. As shown in the figure, the workstation 31 may link with the core network 30, the mobile network 34, or even to the IP network 36. Through the core network 30, an operator may be based on the workstation 31 to directly access the femtocell station 38 over the IP network 36 and the mobile network 34. On the other hand, the operator may also use the workstation 31 to connect the femtocell station 38 over the mobile network 34, preferably a pure mobile network. By means of wireless connection, the invention provides a significant aspect to perform the remote maintenance of the femtocell station 38 by the operator. In the wirelessly signaling process, the workstation 31 conveys configuration signals for the femtocell station 38 over a wireless network. Or alternatively, the signals may also continue to a wired network in the middle of signaling session.

In practice, the one or more operators may remotely shut down the femtocell station 38, check the machine's operation status or statistics data, configure its operating frequency band, Ec/lo, operating power, CQI, and the like. Rather than the conventional way in which the operator needs to go to the machine, or needs to breakthrough many wired network devices to access the terminal machine, the present invention provides a very convenient way for the operators to configure the two-way wireless communication apparatus, such as the current femtocell station 38.

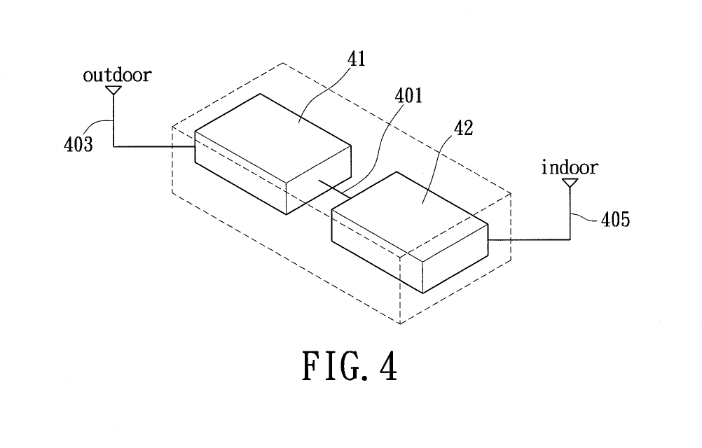

FIG. 4 describes a modular block diagram of the two-way wireless communication apparatus in accordance with the present invention.

According to the present invention, the femtocell station as shown in FIG. 4 showing a two-way wireless communication apparatus may be divided into two major modules. In particular, the two modules include a mobile communication module 41 and its electrically coupled femtocell module 42. The mobile communication module 41 substantially includes uplink and downlink related circuits that can be executed by an ordinary skilled person knowledgeable in the art. In the current embodiment, this mobile communication module 41 substantially has a first antenna 403 for providing wireless signaling.

Furthermore, for the femtocell module 42, the uplink and downlink related circuits are substantially included, and can be executed by an ordinary skilled person in the related arts. The femtocell module 42, while not necessarily, preferably has a second antenna 405 for providing a mobile coverage.

More particularly, the first antenna 403 coupled to the mobile communication module 41 may be an outdoor antenna which is used to bridge the mobile communication signals from a base station. Since the femtocell station may alternatively work as a repeater, this mobile communication module 41 may be used, simply, to span the outdoor mobile signals to the indoors. Furthermore, the femtocell station may also serve as a router which routes the indoor signals out or outdoor signals in. The outdoor antenna conveys third or greater generation or LTE mobile communication signals, namely the wireless signals.

Further, the second antenna 405 coupled to the femtocell module 42 may be an indoor antenna that is used for transceiving the signals generated from the indoor electronic devices. Still further, the indoor antenna conveys the third, greater generation or LTE mobile communication signals.

A signaling connection 401 is particularly being interconnected with the mobile communication module 41 and the femtocell module 42, and used to exchange the downlink and uplink signals there-between. In practice, a cable or any connecting matter practices the signaling connection 401 that is preferably implemented by a USB, or an Ethernet wire.

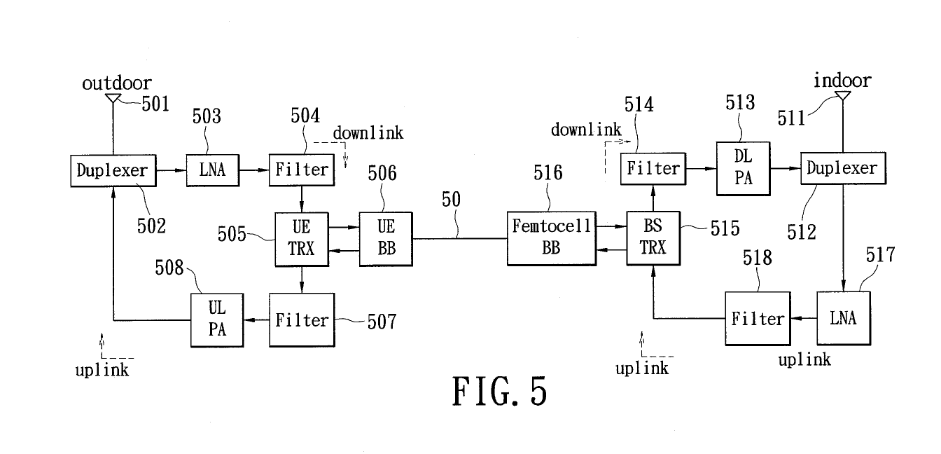

With respect to the signaling connection between the mobile communication module and the femtocell module, the femtocell module particularly has a femtocell baseband circuit linking to a user-equipment (UE) baseband circuit of the mobile communication module. Reference is made to FIG. 5 describing a circuit diagram of the two-way wireless communication apparatus in accordance with the present invention.

According to the above description, the mobile communication module has an outdoor antenna 501 for transceiving the outdoor mobile communication signals, and an indoor antenna 511 for handling the indoor coverage of mobile signals. In further detail for the example, the mobile communication module has circuits along downlink line, such as a duplexer 502, low-noise amplifier (LNA) 503, and a filter 504. The circuits along the downlink line are electrically connected with a user-equipment transceiver (UE TRX) 505 for transmitting and receiving signals. This user-equipment transceiver 505 is used for downconverting signals from the downlink line to the user-equipment baseband 506, or upconverting the signals from the user-equipment baseband 506 to the uplink direction.

The user-equipment baseband 506 is coupled with the user-equipment transceiver 505 and functioned as a connection interface connected with the femtocell baseband 516 via a connection 50. Via the connection 50, the user-equipment baseband 506 delivers signals to the femtocell baseband 516 and receives signals from the femtocell baseband 516.

With respect to the uplink line in the mobile communication module, a filter 507 and an uplink power amplifier (ULPA) 508 are disposed along the uplink line. Since the user-equipment transceiver 505 upcoverts the signals from the user-equipment baseband 506 to the circuits along the uplink line, the signals may then be sent out via the outdoor antenna 501.

In the mobile communication module, the duplexer 502 is used to enable the RF circuit of module to simultaneously transmit and receive the mobile communication signals, that is also to enable the downlink and uplink signals. The low-noise amplifier 503 is used to amplify the weak or low-power downlink signals before delivering to the filter 504. Then the filter 504 is primarily used to shape the signals. The user-equipment transceiver 505 is functioned as a transceiver for downconverting the signals along the downlink direction. Furthermore, while receiving signals from the user-equipment baseband 506, the user-equipment transceiver 505 performs a upconversion on the signals. After the filter 507 shapes the signals, the uplink power amplifier 508 particularly amplifies the signals. These uplink signals afterwards are forwarded to the outdoor antenna 501 through the duplexer 502.

Since the signals are delivered to the femtocell module from the mobile communication module, the femtocell module performs exchange with the indoor signals. In detail, the femtocell module has circuits along downlink direction, such as a duplexer 512, downlink power amplifier (DLPA) 513, and a filter 514. The circuits are further electrically connected with a base-station transceiver (BS TRX) 515 for transmitting and receiving signals. The base-station transceiver 515 is used for downconverting the signals from the femtocell baseband 516 to the downlink line. While delivering, the signals are shaped by the filter 514. The downlink power amplifier 513 then amplifies the signals. Further, the downlink signals are delivered to the indoor antenna 511, and sent to the air. The indoor antenna 511 may also receive the signals from the indoor devices.

Along the uplink direction, a low-noise amplifier (LNA) 517 and a filter 518 are disposed. The low-noise amplifier 517 is used to amplify the weak or low-power signals after receiving signals from the indoor antenna 511 via the duplexer 512. After the filter 518 shapes the signals and delivers to the base-station transceiver 515, the base-station transceiver 515 upconverts the signals and the signals are delivered to the femtocell baseband 516. Via the connection 50, the user-equipment baseband 506 and the femtocell baseband 516 accomplish the exchange of the signals between the outdoor mobile communication signals and the indoor signals.

According to the above description, it is worth noting that the claimed two-way wireless communication apparatus especially implements routing the indoor mobile communication signals to the outdoor mobile networks, and oppositely forwarding the outdoor mobile communication signals for the indoor requests.

In summary, a two-way wireless communication apparatus is disclosed. The two-way wireless communication apparatus mainly includes a mobile communication module and a femtocell module, and therefore be able to convey the mobile signals over a third, greater generation or LTE mobile communication network. It is featured that the claimed apparatus is capable of bridging at least two mobile communication networks.

These descriptions represent solely the more useful and preferred embodiment of the present invention, without any intention to limit the scope of the present invention described here. Various equivalent changes, alternations or modifications based on the claims of present invention are all consequently viewed as being embraced by the scope of the present invention.

What is claimed is:

1. A two-way wireless communication apparatus, comprising:
a mobile communication module, having a first antenna for receiving and transmitting wireless signals;
a femtocell module having a second antenna for providing a mobile coverage; and
a signaling means linking the mobile communication module and the femtocell module, and exchanging downlink and uplink signals there-between.

2. The apparatus of claim 1, wherein the first antenna coupled to the mobile communication module is an outdoor antenna which is used to bridge the mobile communication signals from a base station.

3. The apparatus of claim 2, wherein the outdoor antenna conveys third or greater generation or LTE mobile communication signals.

4. The apparatus of claim 1, wherein the second antenna coupled to the femtocell module is an indoor antenna.

5. The apparatus of claim 4, wherein the indoor antenna conveys third or greater generation or LTE mobile communication signals.

6. The apparatus of claim 1, wherein, by the signaling means, the femtocell module has a femtocell baseband linking to a user-equipment baseband of the mobile communication module.

7. The apparatus of claim 6, wherein the signaling means is implemented by a USB connection.

8. The apparatus of claim 6, wherein the signal means is implemented by an Ethernet connection.

9. A two-way wireless system, comprising:
(a) a femtocell station having:
(i) a mobile communication module having a first antenna for receiving and transmitting wireless signals;
(ii) a femtocell module having a second antenna for providing a mobile coverage;
(iii) a signaling means linking the mobile communication module and the femtocell module, and exchanging downlink and uplink signals there-between; and
(b) a remote computer system, linking with the femtocell station via a wireless network.

10. The system of claim 9, wherein the first antenna coupled to the mobile communication module is an outdoor antenna which is used to bridge the wireless signals from a base station.

11. The system of claim 10, wherein the outdoor antenna conveys mobile communication network signals.

12. The system of claim 11, wherein the remote computer system links with the femtocell station over a third or greater generation or LTE mobile communication network and conveys the mobile communication network signals.

13. The system of claim 9, wherein the second antenna coupled to the femtocell module is an indoor antenna.

14. The system of claim 13, wherein the indoor antenna conveys third or greater generation or LTE mobile communication signals.

15. The system of claim 9, wherein in the femtocell station, by the signaling means, the femtocell module has a femtocell baseband linking to a user-equipment baseband of the mobile communication module.

16. The system of claim 15, wherein the signaling means is implemented by a USB connection.

17. The system of claim 15, wherein the signal means is implemented by an Ethernet connection.

18. The system of claim 9, wherein the remote computer system conveys signals to the femtocell station over a wireless network and continues to a wired network.

19. The system of claim 18, wherein the system further includes a femtocell gateway which is used to bridge the wireless network and the wired network.

20. The system of claim 9, wherein the remote computer system is provided for remotely configuring the femtocell station.
